(19) United States
(12) Patent Application Publication
(10) Pub. No.: US 2012/0262845 A1
(43) Pub. Date: Oct. 18, 2012

(54) MAGNESIUM CAPACITOR AND METHOD FOR PREPARING THE SAME

(75) Inventors: Sang Kyun LEE, Gyeonggi-do (KR); Ji Sung CHO, Gyeonggi-do (KR); Bae Kyun KIM, Gyeonggi-do (KR)

(73) Assignee: SAMSUNG ELECTRO-MECHANICS CO., LTD.

(21) Appl. No.: 13/357,228

(22) Filed: Jan. 24, 2012

(30) Foreign Application Priority Data
Apr. 14, 2011 (KR) 10-2011-0034709

(51) Int. Cl. H01G 9/145; H01G 4/06; H01G 9/02; H01G 9/042; H01G 9/15

(52) U.S. Cl. 361/505; 29/25.03; 361/528; 361/525; 361/524; 361/508

(57) ABSTRACT

The present invention relates to a magnesium capacitor including: a cathode including a carbon material as an active material; an anode including magnesium and its alloys as active materials; and an electrolyte.

Since the magnesium capacitor in accordance with the present invention can use magnesium metal and its alloys as anode materials, a separate pre-doping process of magnesium metal is not needed. Further, it is possible to provide a magnesium capacitor that can be charged and discharged in a predetermined range as well as overcome reduction in stability due to leakage of an electrolyte occurred when using lithium ions as an anode material in the prior art.

### CROSS-REFERENCE TO RELATED APPLICATIONS

Claim and incorporate by reference domestic priority application and foreign priority application as follows:

### Cross Reference to Related Application

This application claims the benefit under 35 U.S.C. Section 119 of Korean Patent Application Serial No. 10-2011-0034709, entitled filed Apr. 14, 2011, which is hereby incorporated by reference in its entirety into this application.

### BACKGROUND OF THE INVENTION

1. Field of the Invention

The present invention relates to a magnesium capacitor and a method for preparing the same.

2. Description of the Related Art

A lithium secondary battery, which has been developed and commercialized mainly for power supplies for electronic devices, power storage, and moving objects, is a main product with high energy density.

Further, an electrochemical capacitor is getting the spotlight as a high quality energy source in the field of renewable energy that can be applied to electric vehicles, hybrid electric vehicles, fuel cell vehicles, heavy equipment, and mobile electronic devices.

Recently, a lithium ion capacitor (LIC) has been proposed for development of a supercapacitor that can satisfy the trend of miniaturization/high capacity. However, since it still has very low capacity compared to a lithium secondary battery, a demand for development of materials to overcome this has risen.

Generally, a carbon material that can interchelate lithium ions is used in an anode of the LIC, but originally, it is more advantageous in terms of energy density to use lithium metal or its alloys.

However, when employing lithium and lithium metal as an anode, there is a problem of ignition of an electrolyte due to repeated charging and discharging. That is, there are limits to using lithium due to problems such as reactivity with moisture. When employing an alloy of lithium as an anode, since lithium ions in a common liquid electrolyte are likely to be formed as needle-like lithium metal dendrites on the anode due to repeated charging and discharging, there is a problem that a battery short is caused by damage to a separator.

Further, in case of a lithium ion capacitor, a pre-doping process of lithium ions is required for the purpose of improvement of energy density as a capacitor. However, even if this pre-doping process is performed, a higher level of lithium ion capacitor is required to provide a high capacity lithium ion capacitor.

### SUMMARY OF THE INVENTION

The present invention has been invented in order to overcome several problems occurred in various conventional energy storage devices such as secondary batteries and capacitors including lithium ions as an active material, and it is, therefore, an object of the present invention to provide a magnesium capacitor capable of providing an energy storage device with high capacity and high energy density by replacing the lithium ions.

Further, it is another object of the present invention to provide a method for preparing a magnesium capacitor with high capacity and high energy density.

In accordance with one aspect of the present invention to achieve the object, there is provided a magnesium capacitor including: a cathode including a carbon material as an active material; an anode including magnesium and its alloys as active materials; and a solid electrolyte.

It may be preferred that the carbon material is activated carbon with a specific surface area of 800 to 3000 m²/g, and a method for preparing the activated carbon is not particularly limited.

The solid electrolyte may act as a solid membrane at the same time.

The solid electrolyte may include a magnesium chloride as an electrolyte salt.

The magnesium chloride may be at least one selected from the group consisting of Mg(ClO₄)₂ and MgBr₂.

The solid membrane may be at least one selected from the group consisting of an organic polymer membrane, an inorganic polymer membrane, and an organic polymer/inorganic composite membrane.

The organic polymer membrane may be at least one selected from the group consisting of a polypropylene polymer, a polysulfone polymer, a polyimide polymer, a polyamide polymer, a polyacrylonitrile polymer, and a cellulose polymer.

It may be preferred that the inorganic polymer membrane may be an oxide of at least one metal selected from the group consisting of silicon (Si), titanium (Ti), zirconium (Zr), aluminum (Al), calcium (Ca), and magnesium (Mg).

An organic polymer of the organic polymer/inorganic composite membrane may be an oxygen (—O—) atom-containing organic polymer compound with a weight average molecular weight of 100,000 to 5,000,000.

An inorganic material of the organic polymer/inorganic composite membrane may be at least one selected from the group consisting of silicon (Si), titanium (Ti), zirconium (Zr), aluminum (Al), calcium (Ca), and magnesium (Mg).

In accordance with another aspect of the present invention to achieve the object, there is provided a magnesium capacitor including: a cathode including a carbon material as an active material; an anode including magnesium and its alloys as active materials; a liquid electrolyte; and a membrane.

The liquid electrolyte may include a magnesium chloride as an electrolyte salt.

The magnesium chloride may be at least one selected from the group consisting of Mg(ClO₄)₂ and MgBr₂.

A solvent of the liquid electrolyte may be at least one selected from the group consisting of propylene carbonate, diethyl carbonate, ethylene carbonate, sulfolane, acetonitrile, dimethoxyethane, tetrahydrofuran, and ethyl methyl carbonate.

The membrane may be at least one selected from the group consisting of an organic polymer membrane, an inorganic polymer membrane, and an organic polymer/inorganic composite membrane.

In accordance with still another aspect of the present invention to achieve the object, there is provided a method for preparing a magnesium capacitor including the steps of: preparing a cathode including a carbon material as an active material; preparing an anode including magnesium and its alloys as active materials; and treating the cathode and the anode with an electrolyte.

The cathode may be prepared by applying a dispersion, in which the active material is dispersed in a binder, on a cathode current collector and drying the applied dispersion.

Further, the cathode may be prepared by including the steps of dispersing the active material in the binder to form the dispersion into a sheet and bonding the sheet and the cathode current collector.

At this time, the binder may be at least one selected from fluorine resin, thermosetting resin, cellulose resin, rubber resin, and siloxane resin.

During preparation of the anode, a separate pre-doping process of magnesium is not included.

The electrolyte may include a solid electrolyte and a liquid electrolyte.

### DETAILED DESCRIPTION OF THE PREFERABLE EMBODIMENTS

Hereinafter, the present invention will be described in detail.

The present invention relates to a magnesium capacitor and a method for preparing the same.

A magnesium capacitor in accordance with an embodiment of the present invention may include a cathode including a carbon material as an active material; an anode including magnesium and its alloys as active materials; and a solid electrolyte including a magnesium chloride as an electrolyte salt.

The magnesium metal ion included as the anode active material is a divalent metal with relatively low standard electrode potential of −2.3V (vs. hydrogen potential). So, when using magnesium as an anode material, it is possible to implement an energy storage device with high volume theoretical capacity (3839 mAh/ml).

Further, since magnesium is a metal which is rich in resources and easy to handle compared to lithium, it can be a good material which can replace lithium metal.

The anode in accordance with the present invention uses magnesium and its alloys as active materials and may use magnesium and its alloys in the form of metal powder or plate.

Further, according to need, slurry is formed by mixing a binder, a conductive agent, and a solvent with magnesium and its alloys, that is, the anode active materials, and applied. At this time, the used binder, conductive agent, and solvent are not particularly limited, and any binder, conductive agent, and solvent, which are used in common secondary batteries and capacitors, are all possible.

An anode current collector in accordance with the present invention may be stainless steel, copper, nickel, and alloys thereof, and among them, copper is preferable. Further, it is preferred that a thickness of the anode current collector is about 10 to 300 μm. As the anode current collector, etched metal foils, expanded metals, punching metals, nets, and forms, which have holes passing through front and rear surfaces, as well as foils of the above metals are possible.

The cathode of the magnesium capacitor of the present invention may use a carbon material as an active material.

It is most preferred that the carbon material is activated carbon, and it is preferred that the activated carbon has a specific surface area of 800 to 3000 m²/g. The raw material of the activated carbon may be coconut residue, phenol resin, petroleum coke, and so on. It is preferred that the raw material of the activated carbon is activated by a steam activation method, a molten KOH activation method, and so on, but the activation method of the raw material of activated carbon is not particularly limited.

Further, the cathode in accordance with the present invention includes a conductive material such as electrical conductive carbon black or graphite to reduce resistance; at least one binder selected from fluorine resins such as polytetrafluoroethylene (PTFE) and polyvinylidene fluoride (PVdF); thermoplastic resins such as polyimide, polyamideimide, polyethylene (PE), and polypropylene (PP); cellulose resins such as carboxymethyl cellulose (CMC); rubber resins such as styrene butadiene rubber (SBR); ethylene propylene diene copolymer (EPDM); polydimethylsiloxane (PDMS); and polyvinylpyrrolidone (PVP); and a solvent.

A cathode current collector may be a thing made of a material used in conventional electric double layer capacitors and lithium ion batteries. For example, the cathode current collector may be at least one selected from the group consisting of aluminum, stainless steel, titanium, tantalum, and niobium, and among them, aluminum is preferable.

It is preferred that the cathode current collector has a thickness of about 10 to 300 μm. As the cathode current collector, etched metal foils, expanded metals, punching metals, nets, and foams, which have holes passing through front and rear surfaces, as well as foils of the above metals are possible.

The solid electrolyte in accordance with the present invention includes a magnesium chloride as an electrolyte salt. The magnesium chloride may be at least one selected from the group consisting of Mg(ClO₄)₂ and MgBr₂. In case of using the magnesium chloride as an electrolyte salt, it is the best electrolyte salt in consideration of dispersibility with respect to an organic polymer when the solid electrolyte is an organic polymer/inorganic composite electrolyte.

When the electrolyte in accordance with an embodiment of the present invention is a solid electrolyte, the solid electrolyte can also perform a role of a solid membrane. Therefore, in this case, a separate membrane is not needed.

A solid membrane which performs roles of a solid electrolyte and a solid membrane at the same time may be at least one selected from the group consisting of an organic polymer membrane, an inorganic polymer membrane, and an organic polymer/inorganic composite membrane.

The organic polymer membrane may be at least one selected from the group consisting of a polypropylene polymer, a polysulfone polymer, a polyimide polymer, a polyamide polymer, a polyacrylonitrile polymer, and a cellulose polymer.

The inorganic polymer membrane may be an oxide of at least one metal selected from the group consisting of silicon (Si), titanium (Ti), zirconium (Zr), aluminum (Al), calcium (Ca), and magnesium (Mg).

Further, an organic polymer used in the organic polymer/inorganic composite membrane may be an oxygen (—O—) atom-containing organic polymer compound with a weight average molecular weight of 100,000 to 5,000,000. For example, it is preferred that the organic polymer as a polyethylene ether compound is at least one selected from polyethylene oxides, polypropylene oxides, polyoxymethylene, and derivates thereof.

The organic polymer is not particularly limited if it can be used as a solid membrane, and has a weight average molecular weight of 100,000 to 5,000,000, preferably, 500,000 to 5,000,000, and most preferably 1,000,000 to 4,000,000.

Further, an inorganic material of the organic polymer/inorganic composite membrane may be at least one selected from the group consisting of silicon (Si), titanium (Ti), zirconium (Zr), aluminum (Al), calcium (Ca), and magnesium (Mg). Among them, metal oxides of silicon, titanium, and zirconium are more preferable, and a silicon oxide (SiO₂) is most preferred due to low cost and easy preparation.

Meanwhile, a magnesium capacitor in accordance with an embodiment of the present invention may include a cathode including a carbon material as an active material, an anode including magnesium and its alloys as active materials, a liquid electrolyte including a magnesium chloride as an electrolyte salt, and a membrane.

That is, when the electrolyte of the magnesium capacitor in accordance with the present invention is a liquid electrolyte, it is preferred that a separate membrane is included. Further, a membrane used at this time may be at least one selected from the group an organic polymer membrane, an inorganic polymer membrane, and an organic polymer/inorganic composite membrane described above.

The magnesium chloride may be at least one selected from the group consisting of Mg(ClO₄)₂ and MgBr₂.

A solvent used in the liquid electrolyte may be selected by considering solubility, reactivity with electrodes, viscosity, and use temperature range of the magnesium electrolyte salt. For a specific example, the solvent may be at least one selected from the group consisting of propylene carbonate, diethyl carbonate, ethylene carbonate, sulfolane, acetonitrile, dimethoxyethane, tetrahydrofuran, and ethyl methyl carbonate, but is not limited thereto.

A method for preparing a magnesium capacitor in accordance with the present invention may include the steps of preparing a cathode including a carbon material as an active material, preparing an anode including magnesium and its alloys as active materials, and treating the cathode and the anode with an electrolyte.

A method for preparing the cathode disperses the activated carbon in a binder such as polyethylene tetrafluoroethylene to form the dispersion into a sheet and bonds the sheet to a cathode current collector. The bonding method may use an electrical conductive adhesive but is not particularly limited thereto.

Further, another method for preparing the cathode the disperses activated carbon in the binder, applies the dispersion on the current collector by a doctor blade method and so on, and dries the applied dispersion, but particularly, two kinds of methods can be all applied to the present invention.

At this time, the binder may be at least one selected from fluorine resin, thermoplastic resin, cellulose resin, rubber resin, and siloxane resin. Specifically, the binder may be polytetrafluoroethylene (PTFE), polyethylene vinylidene fluoride (PVdF), polyimide, polyamideimide, polyethylene (PE), polypropylene (PP), carboxymethyl cellulose (CMC), styrene butadiene rubber (SBR), ethylene propylenediene copolymer (EPDM), polydimethylsiloxane (PDMS), and polyvinylpyrrolidone (PVP), but is not limited thereto.

The anode of the present invention is prepared by using magnesium and its alloys as active materials without a separate pre-doping process of magnesium. Therefore, there is an effect of simplifying processes. Further, it is possible to obtain a high capacity magnesium capacitor without a pre-doping process of magnesium.

The magnesium capacitor in accordance with the present invention can use both a solid electrolyte and a liquid electrolyte. The solid electrolyte and the liquid electrolyte in accordance with the present invention all include a magnesium electrolyte salt. It is preferred that the magnesium electrolyte salt is a magnesium-containing chloride. The magnesium-containing chloride is most preferred due to high solubility in the liquid electrolyte and high dispersibility with respect to an organic polymer in the solid electrolyte.

Next, the magnesium capacitor in accordance with the present invention will be specifically described with reference to the following embodiment, but the present invention is not limited to the following embodiment. The present invention may be variously modified and have several embodiments, and it is to be understood that the present invention includes all modifications, equivalents, and substitutions falling within the spirit and technical scope of the present invention.

### FIRST EMBODIMENT

In the following embodiment, preparation of a cell is all performed in an argon glove box with a dew point of less than −60° C.

(1) Preparation of Cathode

Activated carbon with a specific surface area of about 2200 m²/g, which is obtained by a steam activation method, is used as a cathode active material. Slurry is obtained by mixing respective activated carbon powder, acetylene black, and polyethylene vinylidene fluoride at a weight ratio of 80:10:10, adding the mixture to N-methyl pyrrodidone as a solvent, and stirring and mixing them. After the slurry is applied on an aluminum foil with a thickness of 20 μm by a doctor blade method and temporarily dried, the aluminum foil is cut at an electrode size of 10 cm×10 cm. Before assembly of a cell, the aluminum foil is dried at 120° C. for 10 hours in vacuum.

(2) Preparation of Anode

An anode sheet is obtained by rolling a magnesium metal plate and a copper foil current collector without a separate pre-doping process of magnesium.

(3) Preparation of Electrolyte/Membrane

An organic polymer/inorganic composite solid electrolyte membrane is obtained by dispersing a magnesium electrolyte salt (Mg(ClO₄)₂) 220 g and a silicon oxide (SiO₂) 60 g as an inorganic oxide in a polyethylene oxide with a weight average molecular weight of 1,000,000.

(4) Assembly of Magnesium Capacitor

A pair of electrodes, that is, the cathode prepared in (1) and the magnesium metal anode (two sheets) prepared in (2) are disposed to face each other with the organic polymer/inorganic composite solid electrolyte membrane prepared in (3) interposed therebetween. At this time, since the solid electrolyte membrane performs a role of a membrane as well, a separate membrane is not employed.

### FIRST EXPERIMENTAL EXAMPLE

### Cycle Test of Magnesium Capacitor

A magnesium capacitor was charged to 3.4V for 900 seconds with constant current and voltage and discharged to 2.0V with constant current. After 10 seconds, the magnesium capacitor was repeatedly charged and discharged 10 times under the same conditions. It was checked that the magnesium capacitor can be charged and discharged in the above voltage range.

As above, it was checked that the magnesium capacitor, which can be charged and discharged from 3.4V to 2.0V, can be prepared without a pre-doping process of magnesium metal used as an anode active material. Therefore, it is possible to prepare a price competitive and excellent magnesium capacitor by replacing a conventional lithium capacitor, which uses lithium metal as an anode active material, with magnesium metal.

Since a magnesium capacitor in accordance with the present invention uses magnesium metal and its alloys as anode materials, a separate pre-doping process of magnesium metal is not needed.

Further, it is possible to provide a magnesium capacitor that can be charged and discharged in a predetermined range as well as overcome reduction in stability due to leakage of an electrolyte occurred when using lithium ions as an anode material in the prior art.

Further, since a magnesium capacitor in accordance with the present invention is easy to handle and has high price competitiveness compared to lithium, it has an effect of replacing lithium metal in the field of energy storage devices in the future.

What is claimed is:

1. A magnesium capacitor comprising:
a cathode including a carbon material as an active material;
an anode including magnesium and its alloys as active materials; and
a solid electrolyte.

2. The magnesium capacitor according to claim 1, wherein the carbon material is activated carbon with a specific surface area of 800 to 3,000 m²/g.

3. The magnesium capacitor according to claim 1, wherein the solid electrolyte comprises a magnesium chloride as an electrolyte salt.

4. The magnesium capacitor according to claim 3, wherein the magnesium chloride is at least one selected from the group consisting of Mg(ClO₄)₂ and MgBr₂.

5. The magnesium capacitor according to claim 1, wherein the solid electrolyte acts as a solid membrane at the same time.

6. The magnesium capacitor according to claim 5, wherein the solid membrane is at least one selected from the group consisting of an organic polymer membrane, an inorganic polymer membrane, and an organic polymer/inorganic composite membrane.

7. The magnesium capacitor according to claim 6, wherein the organic polymer membrane is at least one selected from the group consisting of a polypropylene polymer, a polysulfone polymer, a polyimide polymer, a polyamide polymer, a polyacrylonitrile polymer, and a cellulose polymer.

8. The magnesium capacitor according to claim 6, wherein the inorganic polymer membrane is an oxide of at least one metal selected from the group consisting of silicon (Si), titanium (Ti), zirconium (Zr), aluminum (Al), calcium (Ca), and magnesium (Mg).

9. The magnesium capacitor according to claim 6, wherein an organic polymer of the organic polymer/inorganic composite membrane is an oxygen (—O—) atom-containing organic polymer compound with a weight average molecular weight of 100,000 to 5,000,000.

10. The magnesium capacitor according to claim 6, wherein an inorganic material of the organic polymer/inorganic composite membrane is at least one metal selected from the group consisting of silicon (Si), titanium (Ti), zirconium (Zr), aluminum (Al), calcium (Ca), and magnesium (Mg).

11. A magnesium capacitor comprising:
a cathode including a carbon material as an active material;
an anode including magnesium and its alloys as active materials;
a liquid electrolyte; and
a membrane.

12. The magnesium capacitor according to claim 11, wherein the liquid electrolyte comprises a magnesium chloride as an electrolyte salt.

13. The magnesium capacitor according to claim 12, wherein the magnesium chloride is at least one selected from the group consisting of Mg(ClO₄)₂ and MgBr₂.

14. The magnesium capacitor according to claim 11, wherein a solvent of the liquid electrolyte is at least one selected from the group consisting of propylene carbonate, diethyl carbonate, ethylene carbonate, sulfolane, acetonitrile, dimethoxyethane, tetrahydrofuran, and ethyl methyl carbonate.

15. The magnesium capacitor according to claim 11, wherein the membrane is at least one selected from the group consisting of an organic polymer membrane, an inorganic polymer membrane, and an organic polymer/inorganic composite membrane.

16. A method for preparing a magnesium capacitor comprising:
preparing a cathode including a carbon material as an active material;
preparing an anode including magnesium and its alloys as active materials; and
treating the cathode and the anode with an electrolyte.

17. The method for preparing a magnesium capacitor according to claim 16, wherein the cathode is prepared by applying a dispersion, in which the active material is dispersed in a binder, on a cathode current collector and drying the applied dispersion.

18. The method for preparing a magnesium capacitor according to claim 16, wherein preparing the cathode comprises:
dispersing the active material in the binder to form the dispersion into a sheet; and
bonding the sheet and the cathode current collector.

19. The method for preparing a magnesium capacitor according to claim 17 or 18, wherein the binder is at least one selected from fluorine resin, thermoplastic resin, cellulose resin, rubber resin, and siloxane resin.

20. The method for preparing a magnesium capacitor according to claim 16, wherein a separate pre-doping process of magnesium is not included during preparation of the anode.

21. The method for preparing a magnesium capacitor according to claim 16, wherein the electrolyte comprises a solid electrolyte and a liquid electrolyte.
